(19) United States
(12) Patent Application Publication
(10) Pub. No.: US 2003/0036952 A1
(43) Pub. Date: Feb. 20, 2003

(54) Redemption system for award redemption

(76) Inventors: James T. Panttaja, Healdsburg, CA (US); Timothy J.O. Catlin, Belmont, CA (US); Cassandra Wei-Chun Lee, San Francisco, CA (US); Fred A. Kilby, Hercules, CA (US)

Correspondence Address: ROTHWELL, FIGG, ERNST & MANBECK, P.C., 1425 K STREET, N.W., SUITE 800, WASHINGTON, DC, 20005, US

(21) Appl. No.: 09/932,588

(22) Filed: Aug. 17, 2001

(51) Int. Cl. G06F 17/60

(52) U.S. Cl. 705/14

(57) ABSTRACT

A method in a redemption system for determining which awards to redeem is provided. An award history database is maintained that includes award transaction information that describes awards earned by a consumer and, for each earned award, the type of award. An encumbrance database is maintained that describes types of awards that cannot be redeemed at one or more suppliers. A request to redeem an amount of the earned awards with a chosen supplier is received. Allowed awards that can be redeemed at the chosen supplier are determined, and encumbrance levels of the allowed awards are determined based on the types of allowed awards and the data in the encumbrance database. Which of the allowed awards to redeem is determined based on the encumbrance levels.

### BACKGROUND OF THE INVENTION

In general, merchants (e.g., proprietors of goods and services, website operators, etc.) participate in incentive programs to entice customers or consumers to purchase products or services, to encourage consumers to visit their websites more frequently, or to encourage other desired behavior or activity. Typically, a proprietor wants to reward customers for purchasing merchandise and thereby fulfill the goal of conferring the maximum benefit on the customer while minimizing the proprietor's overhead and cost.

Systems have been developed that permit large number of consumers to transact business with large numbers of merchants and earn common currency awards. For example, in one award system, transaction records that include potentially qualifying transactions between participating consumers and participating merchants are received. The merchants may be in diverse industries offering different types of goods and services. The award system processes the potentially qualifying transactions to determine actually qualifying transactions that result in awards to the participating consumers. The determination is done based on certain conditions, for example, whether or not the merchants and consumers are enrolled in the program. For every actual qualified transaction, enrolled consumers automatically receive benefits from enrolled merchants in a common currency. As a result, enrolled consumers need only have a single enrollment to qualify for awards from all types of merchants instead of having individual memberships in each merchant's specific award program.

In such systems, participating consumers may redeem their accumulated currency for a variety of values (e.g., merchandise, gift certificates, airline miles, cash awards, etc.). For example, a consumer who may have acquired award currency based on shopping at gas stations, supermarkets or dry cleaners can redeem that award currency for goods or services at a participating clothing retailer.

The redemption of earned awards by a consumer may be restricted by certain limitations. For example, some awards may expire after certain time, and cannot be redeemed after their expiration. Additionally, some businesses may not permit redemption of awards that were earned through certain promotions and/or merchants.

Techniques have been developed for determining which of the earned awards to redeem when a consumer requests a redemption. For example, if the business at which the consumer wishes to redeem does not accept awards earned through certain promotions and/or merchants, then such earned awards are excluded from the determination. The eligible awards may be selected based on the expiration date of the awards. Particularly, awards with an earlier expiration will be redeemed before awards with a later expiration.

### BRIEF SUMMARY OF THE INVENTION

In one embodiment according to the present invention, a method in a redemption system for determining which awards to redeem is provided. The method comprises maintaining an award history database that includes award transaction information that describes awards earned by a consumer and, for each earned award, the type of award. The method also comprises maintaining an encumbrance database that describes types of awards that cannot be redeemed at one or more suppliers, and receiving a request to redeem an amount of the earned awards at a chosen supplier. The method additionally comprises determining allowed awards that can be redeemed at the chosen supplier, and determining encumbrance levels of the allowed awards based on the types of allowed awards and the data in the encumbrance database. The method further comprises determining which of the allowed awards to redeem based on the encumbrance levels.

In another embodiment, a further method in a redemption system for determining which awards to redeem is provided. The method includes maintaining an award history database that includes award transaction information that describes awards earned by a consumer and including, for each earned award, an expiration date and an earning date. The method additionally includes receiving a request to redeem an amount of the earned awards, and determining allowed awards that may be redeemed based on the expiration date. The method also includes determining which of the allowed awards to redeem based on the earning date.

In yet another embodiment, a system, in a network promotion system, for determining which awards to redeem is provided. The system comprises a first memory that stores award transaction information that describes awards earned by a consumer and, for each earned award, the type of award. The system also comprises a second memory that stores information related to types of awards that cannot be redeemed at one or more suppliers. The system additionally comprises a processor coupled to the first memory and the second memory and operable to perform the steps of receiving a request to redeem an amount of the earned awards at a chosen supplier, and determining allowed awards that can be redeemed at the chosen supplier. Also, the processor is further operable to perform the steps of determining encumbrance levels of the allowed awards based on the types of allowed awards and the data in the encumbrance database, and determining which of the allowed awards to redeem based on the encumbrance levels.

In still another embodiment, another system, in a network promotion system, for determining which awards to redeem is provided. The system includes an award history database that stores award transaction information that describes awards earned by a consumer and, for each earned award, an expiration date and an earning date. The system also includes a processor coupled to the award history database and operable to perform the steps of receiving a request to redeem an amount of the earned awards, and determining allowed awards that may be redeemed based on the expiration date. The processor is also operable to perform the step of determining which of the allowed awards to redeem based on the earning date.

Advantages of the present invention include providing improved methods and systems for determining which awards to redeem. These and other embodiments of the present invention, as well as its advantages and features are described in more detail in conjunction with the text below and attached Figures.

### BRIEF DESCRIPTION OF THE DRAWINGS

FIG. 1 is a simplified block diagram of one example of an incentive system in which the present invention may be embodied;

FIG. 2 is a simplified block diagram of one example of an award system at a clearinghouse in which the present invention may be embodied;

FIG. 3 is a simplified diagram of one embodiment of a data structure for a transaction history database implemented in accordance with the present invention;

FIG. 4 is a simplified diagram of one embodiment of a data structure for an encumbrance database implemented in accordance with the present invention;

FIG. 5 is a simplified flow diagram illustrating a basic redemption operation of an award system;

FIG. 6 is a simplified flow diagram of one embodiment of a method for redeeming awards from a transaction history database;

FIG. 7 is a simplified flow diagram illustrating one embodiment of a method for selecting awards for redemption;

FIG. 8 is a simplified diagram of one embodiment of a data structure that includes black-out information; and

FIG. 9 is a simplified diagram of one embodiment of a data structure that includes award classification information.

### DESCRIPTION OF THE SPECIFIC EMBODIMENTS

Brief Explanation of Terms

A consumer is any entity, whether an individual, organization, or business, for which a merchant desires to transfer or confer value.

A merchant generally refers to any entity that desires to transfer or confer value to a consumer in exchange for certain behavior or activity.

A clearinghouse denotes an entity that redeems consumer value, conferred by the merchant, for goods or services of suppliers.

Incentive Systems in Which the Present Invention Might be Embodied

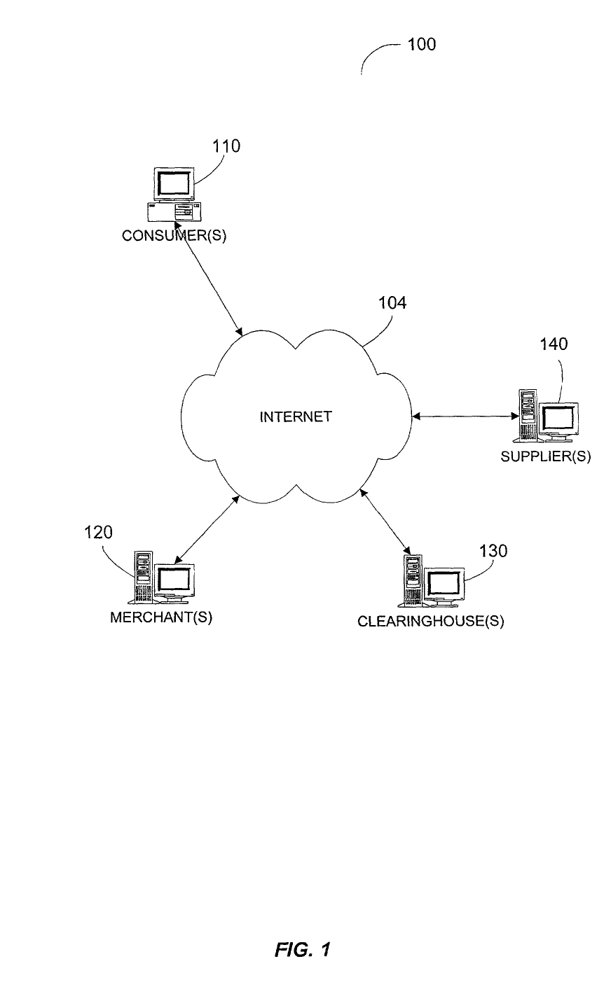

FIG. 1 is a simplified block diagram of one example of an incentive system 100 in which the present invention may be embodied. This diagram is used herein for illustrative purposes only and is not intended to limit the scope of the invention. The incentive system 100 is an incentive system coupled to a network (in this example, the Internet) and three entities are shown: a consumer 110, a merchant 120, and a clearinghouse 130. For simplicity of explanation, the consumer, merchant, and clearinghouse are referred to in the singular form. However, a typical incentive system includes many consumers and merchants, and may include a plurality of clearinghouses. In one embodiment, consumer 110, merchant 120, and clearinghouse 130 are coupled to the Internet 104.

In this embodiment, the communications to support a value transfer from the merchant to the consumer, and the subsequent redemption by the consumer occur over the Internet 104. However, any form of communication may also be used for value transfer and/or redemption, such as, for example, an internet, an intranet, an extranet, a wide area network, a direct connection via telephone, T1, T3, cellular, microwave, satellite, etc.

In this embodiment, to receive value, the consumer 110 may visit a web site of merchant 120 using, for example, a web browser such as Netscape® Navigator, Microsoft® Explorer, etc., and the consumer 110 enters an “earning activity” specified by the merchant 120. The earning activity may include any behavior or activity the merchant seeks from the consumer 110. Examples of earning activities include, but are not limited to, reading an advertisement posted on a merchant's web page, completing a survey, signing up for a service, purchasing a product or products, etc. Once the consumer 110 has completed the earning activity to the satisfaction of the merchant 120, value for the earning activity is transferred from the merchant 120 to the clearinghouse 130. Such values will hereinafter be referred to as “awards.” Thereafter, the consumer 110 may contact, for example, a web site supported by the clearinghouse 130 to redeem awards for goods and/or services.

In this embodiment, one or more merchants 120 are associated with clearinghouse 130. Generally, the awards earned by the consumer 110 are not bound to a specific redemption item, such as frequent flyer miles, or bound to a specific catalog. In this system, consumer 110 may earn awards from different merchants who participate in the incentive program for deposit, and subsequent redemption of the awards at a repository (e.g., clearinghouse 130). In some embodiments, the awards earned by a consumer are measured in points, and the consumer 110 redeems “X” points for “Y” amount of goods and/or services.

In this embodiment, clearinghouse 130 is coupled to one or more suppliers 140 via Internet 104. However, clearinghouse 130 may be coupled with suppliers 140 via other forms of communication such as, for example, an internet, the Internet, an intranet, an extranet, a local area network, a wide area network, a direct connection via telephone, T1, T3, cellular, microwave, satellite, etc. In general, clearinghouse 130 operates as a repository of data about awards earned by the consumer 110 at one or more merchants 120. Clearinghouse 130 transforms the awards earned by the consumer for some form of value provided by the supplier 140. For example, consumer 110 may redeem the earned awards for frequent flyer miles. In this example, supplier 140 may be an airline or airline coalition that awards frequent flyer miles to the consumer after the clearinghouse 130 transfers hard currency to the supplier. Other examples of value provided by the supplier for which the consumer 110 may redeem its earned awards include, but are not limited to, cash, credit, tangible goods, services, etc.

When a consumer wishes to redeem earned awards, the clearinghouse 130 must determine which of the earned awards to redeem. Determining which awards to redeem may be based on various factors. For example, earned awards may expire after a period of time. Similarly, certain suppliers may not recognize awards earned at certain merchants or earned via certain promotions. Thus, the clearinghouse determines which awards have not expired and are eligible for a redemption at the chosen supplier. Similarly, the clearinghouse may select eligible awards that will expire the soonest so that the consumer does not redeem awards that, for example, might not have expired for months while leaving awards that were set to expire the next day. The present invention provides improved systems and methods for selecting earned awards for redemption.

Further details of the incentive system described above are provided in U.S. Pat. No. ______ (U.S. Pat. application Ser. No. 09/167,315 to Catlin and Rowney, filed Oct. 6, 1998, and entitled “An On-Line Incentive System”) (hereinafter “Catlin”). Catlin is herein incorporated by reference for all purposes.

Another incentive system in which the present invention may be embodied is described in U.S. Pat. No. ______ (U.S. Pat. application Ser. No. 09/637,387 to Haugen and Rowney, filed Aug. 11, 2000, and entitled “Low Authentication Promotion Algorithm and Circuit Breaker”) (hereinafter “Haugen”), which is herein incorporated by reference for all purposes. Haugen describes a system for use with on-line Low Authentication Promotion (LAP) programs. In LAP programs, consumers may earn awards for activities while providing only minimal information about themselves. For example, a consumer might only need to provide an email address to begin earning awards.

In the incentive system described with respect to FIG. 1, a consumer earns awards by performing an earning activity at a merchant's web site. However, the present invention may be embodied in incentive systems in which consumers earn awards by other activities as well. For example, U.S. Pat. No. ______ (U.S. Pat. application Ser. No. 09/637,422 to Scognamillo, filed Aug. 11, 2000, and entitled “Transaction Based Award Program”) (hereinafter “Scognamillo”) describes a transaction based award system in which the present invention may also be embodied. Scognamillo is herein incorporated by reference for all purposes. In systems described in Scognamillo, consumers may earn awards based upon transactions with merchants that use an electronic transaction record. Such transactions can include, but are not limited to, transactions using payment mechanisms such as credit cards, debit cards, check truncations, electronic funds transfer, digital cash, etc. Further details of such systems are described in Scognamillo.

The present invention may be embodied in other incentive systems similar to those described in Catlin, Haugen, and Scognamillo.

A Redemption System

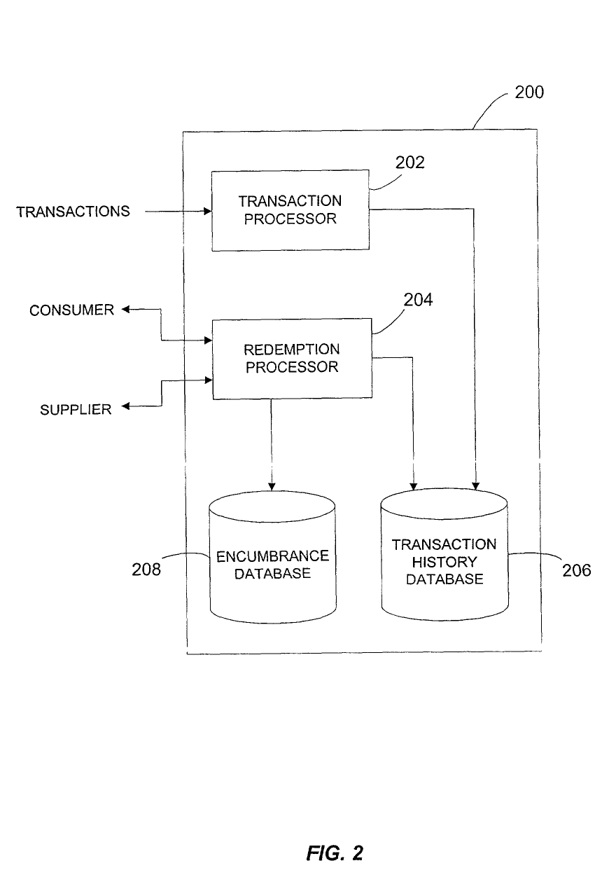

FIG. 2 is a simplified block diagram of one example of an award system at a clearinghouse in which the present invention may be embodied. This diagram is used herein for illustrative purposes only and is not intended to limit the scope of the invention.

The award system 200 includes a transaction processor 202, a redemption processor 204, a transaction history database 206, and an encumbrance database 208. Generally, the transaction processor 202 receives and processes transaction information, and then stores processed transaction information in the transaction history database 206. Depending upon the particular incentive system in which the award system 200 operates, the transaction information received by transaction processor 206 can be received from various entities and can vary in content depending upon the particular incentive system. For example, the transaction information can be received from merchants via the Internet (or whatever particular communication link is used). Similarly, the transaction information can be received from a transaction reporting system in a credit card transaction system. Detailed information about the transaction processor 206 is not presented here as details are generally known to one of ordinary skill in the art. Further details of transaction processors are described in Catlin, Haugen, and Scognamillo.

Redemption processor 204 receives redemption requests from consumers, and examines data in the transaction history database 206 and the encumbrance database 208 to determine which awards to redeem for the consumer using methods according to the invention that are described subsequently. Upon determining the awards to be redeemed, the redemption processor communicates the redemption to a supplier chosen by the consumer. The redemption processor may interface with the consumers and the suppliers via the Internet or whatever particular communication link might be used.

For example, the redemption processor 204 may receive a request to redeem N awards at a supplier A. The redemption processor 204 then examines data in the transaction history database 206 and the encumbrance database 208 to determine N awards earned by the consumer that can be redeemed at the supplier A. Next, the redemption processor 204 notifies supplier A that the consumer has redeemed N awards. For example, if supplier A is an airline, and the consumer chooses to redeem N awards for frequent flyer miles, the redemption processor 204 may notify the airline that the consumer's frequent flyer account should be credited for K miles, where K is determined by some function of the number of awards redeemed.

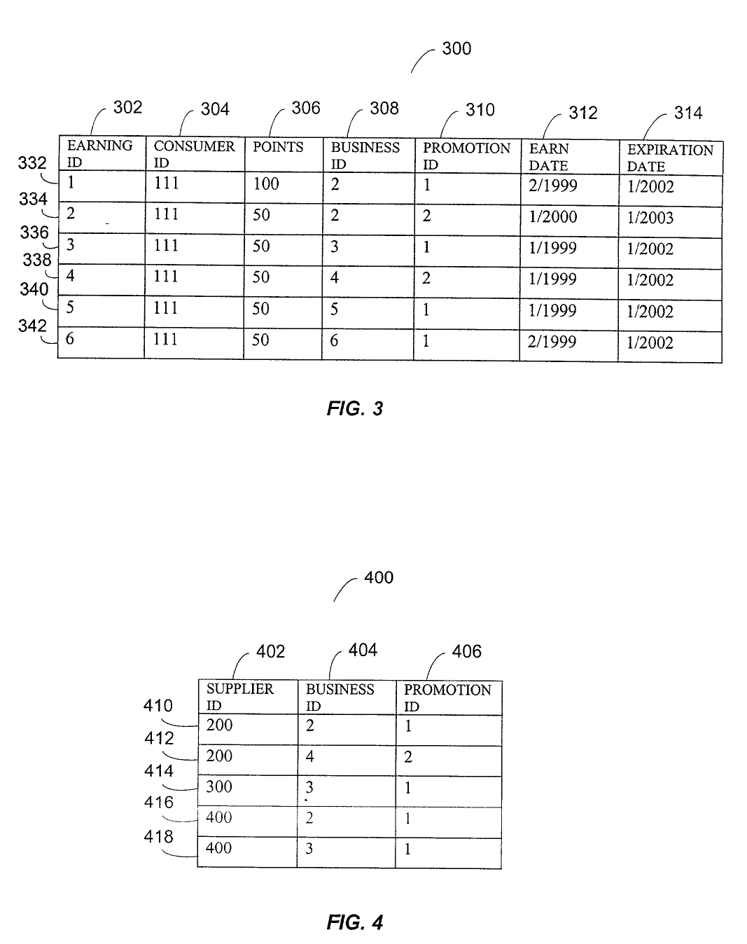

FIG. 3 is a simplified diagram of one embodiment of a data structure 300 for the transaction history database 206 implemented in accordance with the present invention. This diagram is used herein for illustrative purposes only and is not intended to limit the scope of the invention.

Various information related to a transaction may be stored in the transaction history database 206. In FIG. 3, the transaction history database 206 is shown including a transaction table 300. Transaction table 300 is shown including an Earning Identifier (ID) column 302, a Consumer ID column 304, a Points column 306, a Business ID column 308, a Promotion ID column 310, an Earn Date column 312, and an Expiration Date column 314. The Earning ID is an identifier for the particular transaction. The consumer ID is an identifier of the consumer that participated in the transaction. The Points indicate how many points were earned by the consumer for this transaction. In this embodiment, awards are measured in points. However, in other embodiments, other types of awards or award measurements may be used. The Business ID is an identifier of the merchant involved in the transaction for which the consumer is awarded points. The Promotion ID is an identifier of a particular promotion according to which the consumer was awarded points for this transaction. The Earn Date is the date on which the consumer was awarded the points. The Expiration Date is the date on which the points will expire. For example, row 332 indicates that a consumer identified by “111” earned awards equaling 100 points at business “2” according to promotion “1”. These points were earned in February 1999 and will expire in January 2002. Although records for only one consumer are shown, it should be understood that transaction table 300 typically holds records for many consumers.

Referring again to FIG. 2, the encumbrance database 208 includes information related to restrictions on redeeming particular awards at particular suppliers. For example, supplier A may not want to allow consumers to redeem points at supplier A that were earned in transactions with merchant Y. Similarly, supplier A may not want to allow consumers to redeem points at supplier A that were earned in particular transactions with merchant Y. For example, supplier A might want to exclude awards earned with merchant Y via a promotion Z.

FIG. 4 is a simplified diagram of one embodiment of a data structure 400 for the encumbrance database 208 implemented in accordance with the present invention. This diagram is used herein for illustrative purposes only and is not intended to limit the scope of the invention. In this embodiment, the encumbrance database includes an encumbrance table 400. Encumbrance table 400 includes a Supplier Identifier (ID) column 402, a Business ID column 304, and a Promotion ID column 306. The Supplier ID is an identifier of a particular supplier. The Supplier ID is an identifier of a supplier at which awards may be redeemed. The Business ID and Promotion ID are identifiers of a merchant and promotion, respectively, for which the corresponding supplier will not redeem awards. For example, the data in row 410 indicate that Supplier “200” will not redeem points that were earned at merchant “2” via promotion “1”.

Basic Operation

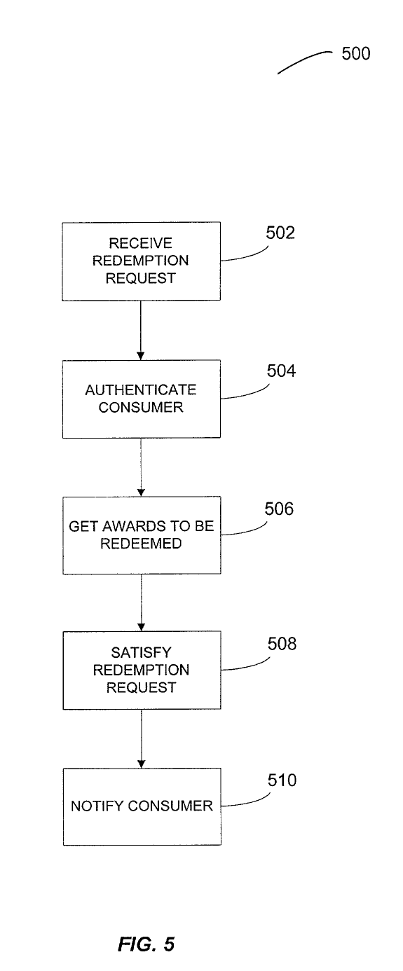

FIG. 5 is a simplified flow diagram illustrating a basic redemption operation of an award system. This diagram is used herein for illustrative purposes only and is not intended to limit the scope of the invention. In a step 502, the award system receives a request to redeem awards from a consumer. The request includes a consumer identifier, account number, etc. In some embodiments, the request also includes the amount of awards the consumer wishes to redeem and the supplier at which to redeem the points. In other embodiments, the request includes a good, service, number of frequent flyer miles, etc., for which the consumer wishes to redeem awards. In response, the award system determines the amount of awards necessary to redeem the request and at which supplier the awards will be redeemed. One skilled in the art will recognize many other variations, alternatives, and equivalents.

Next, in a step 504, the consumer is authenticated. Any number of techniques for authentication including those known to one skilled in the art may be used. For example, Catlin, Haugen, and Scognamillo describe various methods and systems for authentication.

After the consumer has been authenticated, the redemption processor gets awards to be redeemed in a step 506. As described with respect to FIG. 2, the redemption processor 204 determines which of the awards attributed to the consumer in transaction history database 206 to redeem based on information in the transaction history database 206 and the encumbrance database 208. Determining awards to be redeemed will be described in more detail below.

Once the awards to be redeemed have been determined, the redemption request is satisfied in a step 508. Satisfying the redemption request includes deducting the redeemed amount from an award balance of the consumer, and transferring the redeemed value to the requested supplier. For example, if the redemption was for frequent flyer miles, the supplier is notified of the number of miles to be credited to the consumer's frequent flyer account.

Finally, in a step 510, the consumer is notified of the redemption. For example, the consumer may receive an email, be prompted with a web page, receive a notice in the mail, etc., that notifies the consumer of the amount of awards redeemed and the value for which the awards were redeemed. For example, if the consumer redeemed awards for frequent flyer miles, the consumer is notified of the amount of awards redeemed and the number of frequent flyer miles received.

Redeeming Awards

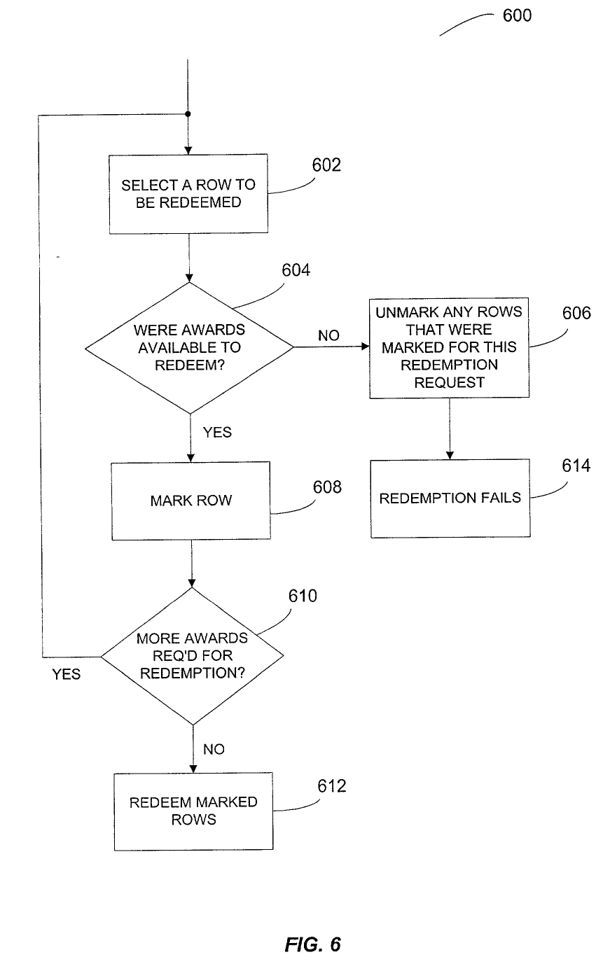

FIG. 6 is a simplified flow diagram illustrating a basic operation of a redemption system. Particularly, FIG. 6 illustrates one embodiment of a method for redeeming awards from a transaction history database. This diagram is used herein for illustrative purposes only and is not intended to limit the scope of the invention.

The flow diagram of FIG. 6 will be described with reference to FIG. 3. First, in a step 602, a row in the transaction table 300 corresponding to an award transaction of the requesting consumer is selected for redemption. In embodiments using a data structure such as shown in FIG. 3, the selection of the row is based upon the Consumer ID. As is described in more detail below, it may also be based upon one or more of the Expiration Date, the Earn Date, the Business ID, and the Promotion ID.

Next, in a step 604, it is determined whether any awards were selected in step 602. For instance, a consumer may not have any more awards available for redemption. Or, the consumer may not have any more awards available for this specific redemption request. For example, the consumer may have available awards that were earned at merchant “A”, but the supplier specified in the redemption request does not honor awards earned at merchant “A”.

If no awards were selected in step 602, then the flow proceeds to a step 606. However, if awards were selected in step 602, then the flow proceeds to a step 608. In step 608, the selected row of awards are marked as preliminarily used, and the flow proceeds to a step 610.

In step 610, it is determined whether more awards are required for the redemption request. For example, if the redemption request requires 500 points, and rows corresponding to 200 points have thus far been marked, then more awards are required for the redemption request. If more awards are still required, then the flow proceeds back to step 602. However, if no more awards are required, then the flow proceeds to a step 612.

In step 612, the rows marked in step 608 as preliminarily used are redeemed. This may include marking such rows as permanently used, or deleting such rows. In many cases, more awards are marked as preliminarily used than are needed for the redemption request. In some embodiments, only the required portion of the awards in the last marked row are redeemed. For example, if the redemption request requires 500 points, rows corresponding to 530 points may have been marked, and the last row marked may have had 50 corresponding points. Thus, in the last row marked, only 20 points are redeemed, leaving 30 points for future redemptions.

As described above, if in step 602 no rows were selected, then the flow proceeds to step 606. In this case, there are not enough awards to satisfy the consumer's redemption request. Thus, in step 606 any awards that had previously marked are unmarked so that they are available for future redemptions. Then, the flow proceeds to step 614, where the redemption fails.

Selecting Awards For Redemption

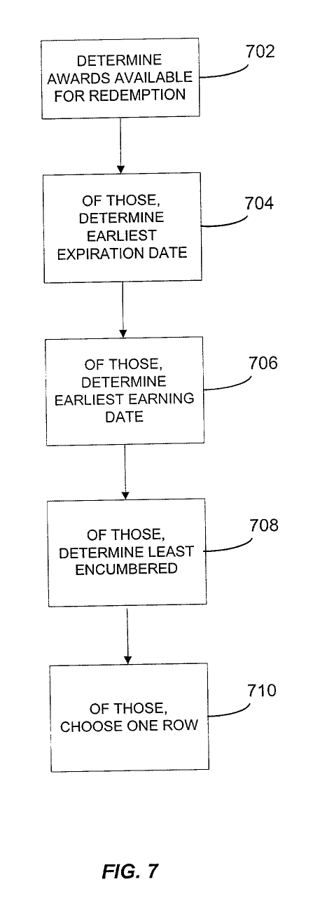

FIG. 7 is a simplified flow diagram illustrating one embodiment of a method for selecting awards for redemption. For example, this method may be used to implement step 602 of FIG. 6. This diagram illustrated in FIG. 7 is used herein for illustrative purposes only and is not intended to limit the scope of the invention. FIG. 7 will be described with reference to FIGS. 3 and 4.

First, in a step 702, awards that are available for redemption are determined. This may include determining awards earned by the consumer that have not yet expired and that may be redeemed at the chosen supplier. For example, a consumer may request to redeem points at a supplier “400”. Referring to FIG. 4, the encumbrance database indicates that supplier “400” will not accept awards earned at business “2” via promotion “1”, nor at business “3” via promotion “1”. Thus, the rows of awards available for redemption are rows 334, 338, 340, and 342.

Next, in a step 704, of the awards available for redemption, the earliest expiration date of those awards is determined. In the example above, of rows 334, 338, 340, and 342, the earliest expiration is January 2002, which corresponds to rows 338, 340, and 342. Next, in a step 706, of the available awards with the earliest expiration date, the earliest earning date is determined. In this example, of rows 338, 340, and 342, the earliest earning date is January 1999, which corresponds to rows 338 and 340.

Then, in a step 708, of the available awards with the earliest expiration date and with the earliest earning date, the least encumbered awards are determined. In the above example, the available awards with the earliest expiration date and with the earliest earning date correspond to rows 338 and 340. The awards corresponding to row 338 were earned at business “4” according to promotion “2”. Referring now to FIG. 4, row 412 indicates that awards earned at business “4” according to promotion “2” are not accepted by supplier “200”. Thus, the awards corresponding to row 338 are encumbered. On the other hand, the awards corresponding to row 340 were earned at business “5” according to promotion “1”. Referring to table 400, these awards are not encumbered. Thus, in step 708, row 340 is the least encumbered of the awards.

Next, in a step 710, if multiple rows of available awards with the earliest expiration date, with the earliest earning date, and the most encumbered are identified, then one of the rows is chosen. Any number of techniques can be used to select one of the rows. For example, other criteria may be used to decide, one may be chosen randomly, etc.

The ordering of steps 704, 706, and 708 in FIG. 7 reflects priorities given to the three criteria for selecting awards to redeem. Namely, the expiration date of awards is the highest priority, then the earning date, followed by the encumbrance of awards. However, a business environment may dictate another priority ranking. Thus, it is to be understood that steps 704, 706, and 708 may be performed in various orders depending upon, for example, a business-related decision on the importance of the three criteria. Further, it is to be understood that all three steps need not be performed. For instance, only one of the three, or any two of the three can be performed.

A Weighted Decision

In other embodiments, selecting awards for redemption may be implemented as some weighted function of the various criteria, rather than performing steps 704, 706, and 708. For example, the function:

F=A(Time_Till_Exp)+B(Time_From_Earn)+C(Num_Encumb) (1)

can be applied to the rows of available awards in table 300, where Time_Till_Exp is the amount of time till the awards expire, Time_From_Earn is the amount of time since the awards were earned, Num_Encumb is the number of encumbrances on the awards, and A, B, and C are weighting factors that can be adjusted based upon the relative weight that is desired to be assigned to each of the three criteria. Then, available rows of awards may be selected by determining the rows that minimize the function F. As described with respect to steps 704, 706, and 708 of FIG. 7, the function need not be a function of all three criteria. For example, it may be a function of only one, or any two of the criteria. Equation 1 shows each criteria being multiplied by a weight, however other functions of the criteria may be used. For example, the function may be a non-linear function of the various criteria, and in the general case, F is calculated using a function as shown in Equation 2.

F=f(Time_Till_Exp,Time_From_Earn,Num_Encumb) (2)

Variations

Many variations of the invention will become apparent to those of skill in the art upon review of this disclosure. For example, in the above-described embodiments, the award data and the data used to determine which awards to redeem are stored in tabular data structures. However, other data structures may also be used with the present invention.

Also, in the above-described embodiments, encumbrance of awards is measured in terms of restrictions on redeeming the awards at certain suppliers. Particularly, awards are encumbered if one or more suppliers will not accept them for redemption because they were earned at certain merchants via certain promotions. However, in other embodiments, awards might not be differentiated by promotions, and awards are encumbered based upon whether suppliers will not accept them for redemption because they were earned at certain merchants. Also, awards may be encumbered based on other criteria besides supplier-specific restrictions. For example, in some embodiments, certain awards might be encumbered by black-out dates on which the awards are not yet expired but cannot be redeemed. FIG. 8 is a simplified diagram of one embodiment of a data structure 800 that includes black-out information. This diagram is used herein for illustrative purposes only and is not intended to limit the scope of the invention. In this embodiment, the table 800 includes a Business ID column 802, a Promotion ID column 804, a Black-Out Start column 806, and a Black-Out End column 808. The Business ID and Promotion ID are identifiers of a merchant and promotion, respectively, for which corresponding awards cannot be redeemed during certain black-out dates. Black-Out Start and Black-Out End specify the black-out period. For example, the data in row 812 indicate that points earned at merchant “2” via promotion “1” cannot be redeemed during the period starting May 3, 2001, and ending May 29, 2001. Thus, a redemption system might, for example, try to redeem awards with black-out dates before redeeming points without black-out dates.

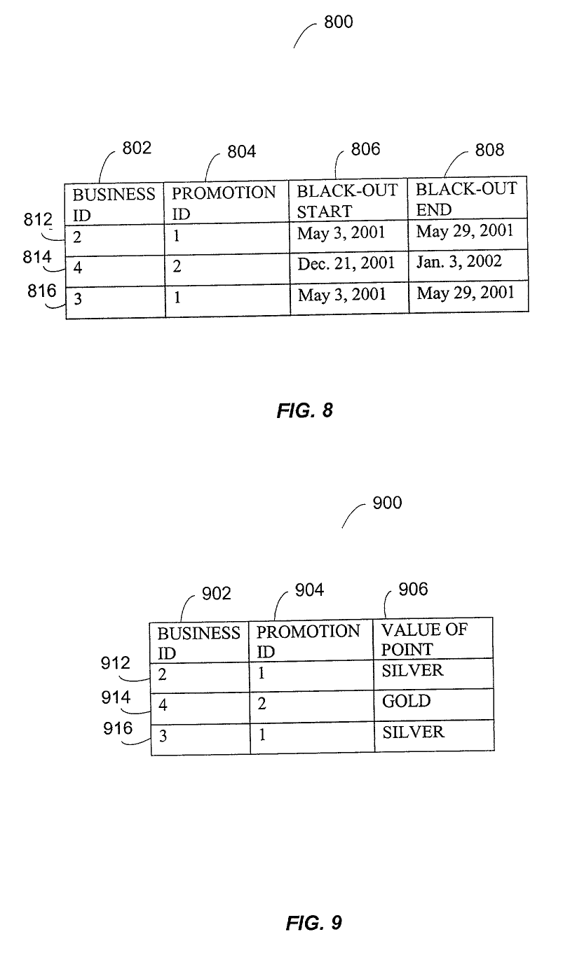

Additionally, awards may be classified into different types of awards. For example, if a consumer performs some special earning activity, the consumer might receive special awards that permitted redemption for certain goods, services, etc., that cannot be redeemed with normal awards. Thus, a redemption system might, for example, try to redeem normal awards before redeeming special awards. FIG. 9 is a simplified diagram of one embodiment of a data structure 900 that includes award classification information. This diagram is used herein for illustrative purposes only and is not intended to limit the scope of the invention. In this embodiment, the table 900 includes a Business ID column 902, a Promotion ID column 904, and a Value of Point column 906. The Business ID and Promotion ID are identifiers of a merchant and promotion, respectively, for which corresponding awards have a specified value. Value of Point specifies the value. For example, the data in row 912 indicate that points earned at merchant “2” via promotion “1” are “SILVER” points. The date in row 914 indicate that points earned at merchant “4” via promotion “2” are “GOLD” points. Select goods, services, etc., might be redeemable only with “GOLD” points. Thus, a redemption system might, for example, try to redeem SILVER awards before redeeming GOLD awards.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A method in a redemption system for determining which awards to redeem, the method comprising:
maintaining an award history database that includes award transaction information that describes awards earned by a consumer and, for each earned award, the type of award;
maintaining an encumbrance database that describes types of awards that cannot be redeemed at one or more suppliers;
receiving a request to redeem an amount of the earned awards at a chosen supplier;
determining allowed awards that can be redeemed with the chosen supplier;
determining encumbrance levels of the allowed awards based on the types of allowed awards and the data in the encumbrance database; and
determining which of the allowed awards to redeem based on the encumbrance levels.

2. The method of claim 1 wherein determining which of the allowed awards to redeem is further based on expiration dates of the allowed awards.

3. The method of claim 1 wherein determining which of the allowed awards to redeem is further based on dates on which the allowed awards were earned.

4. The method of claim 1 wherein the type of award includes according to which promotion the award was earned.

5. The method of claim 1 wherein the type of award includes from which business the award was earned.

6. The method of claim 1 wherein the type of award indicates black-out dates on which the award cannot be redeemed.

7. The method of claim 1 wherein the type of award indicates a classification of the award.

8. A method in a redemption system for determining which awards to redeem, the method comprising:
maintaining an award history database that includes award transaction information that describes awards earned by a consumer and including, for each earned award, an expiration date and an earning date;
receiving a request to redeem an amount of the earned awards;
determining allowed awards that may be redeemed based on the expiration date; and
determining which of the allowed awards to redeem based on the earning date.

9. The method of claim 8 wherein the award history database further includes, for each earned award, the type of award, the method further comprising:
maintaining an encumbrance database that describes restrictions on redeeming types of awards; and
wherein determining allowed awards is further based on the types of the awards.

10. The method of claim 9 wherein determining which of the allowed awards to redeem is further based on the types of the allowed awards.

11. The method of claim 9 wherein the encumbrance database describes types of awards that cannot be redeemed at one or more suppliers;
wherein receiving a request to redeem further comprises receiving an indication of a chosen supplier at which to redeem the awards; and
wherein determining allowed awards is further based on the chosen supplier.

12. The method of claim 9 wherein the type of award depends on the promotion with which the award was earned.

13. The method of claim 9 wherein the type of award depends on the business with which the award was earned.

14. The method of claim 9 wherein the type of award depends on black-out dates on which the award cannot be redeemed.

15. The method of claim 9 wherein the type of award indicates a classification of the award.

16. The method of claim 9 further comprising:
determining encumbrance levels of the allowed awards based on the types of allowed awards and the data in the encumbrance database; and
wherein determining which of the allowed awards to redeem is further based on the encumbrance levels.

17. In a network promotion system, a system for determining which awards to redeem, the system comprising:
a first memory that stores award transaction information that describes awards earned by a consumer and, for each earned award, an expiration date and an earning date;
a second memory that stores information related to types of awards that cannot be redeemed at one or more suppliers;
a processor coupled to the first memory and the second memory and operable to perform the steps of:
receiving a request to redeem an amount of the earned awards at a chosen supplier;
determining allowed awards that can be redeemed at the chosen supplier; and
determining encumbrance levels of the allowed awards based on the types of allowed awards and the data in the encumbrance database; and
determining which of the allowed awards to redeem based on the encumbrance levels.

18. The system of claim 17 wherein the first memory and the second memory are a common memory with storage areas for award transaction information and information related to types of awards that cannot be redeemed at one or more suppliers.

19. In a network promotion system, a system for determining which awards to redeem, the system comprising:
an award history database that stores award transaction information that describes awards earned by a consumer and, for each earned award, an expiration date and an earning date; and
a processor coupled to the award history database and operable to perform the steps of:
A) receiving a request to redeem an amount of the earned awards;
B) determining allowed awards that may be redeemed based on the expiration date; and
C) determining which of the allowed awards to redeem based on the earning date.

20. The system of claim 19 further comprising an encumbrance database that describes restrictions on redeeming types of awards;
wherein the processor is coupled with the encumbrance database; and
wherein the processor is configured to determine allowed awards further based on the types of awards.

21. The system of claim 20 wherein determining which of the allowed awards to redeem is further based on the types of the allowed awards.
